(19) United States
(12) Patent Application Publication
(10) Pub. No.: US 2025/0093597 A1
(43) Pub. Date: Mar. 20, 2025

(54) OPTO-ELECTRICAL CONNECTION SYSTEM, AND OPTO-ELECTRICAL CONNECTOR

(71) Applicant: Sumitomo Electric Industries, Ltd., Osaka-shi (JP)

(72) Inventors: Yasunori ASANO, Osaka-shi (JP); Takeshi INOUE, Osaka-shi (JP)

(73) Assignee: Sumitomo Electric Industries, Ltd., Osaka-shi (JP)

(21) Appl. No.: 18/886,389

(22) Filed: Sep. 16, 2024

(30) Foreign Application Priority Data
Sep. 20, 2023 (JP) 2023-152737

(51) Int. Cl. G02B 6/42

(52) U.S. Cl. CPC G02B 6/4278; G02B 6/423; G02B 6/426

(57) ABSTRACT

An opto-electrical connection system includes a first connector and a second connector. The first connector includes a plurality of first conductors, a plurality of first optical fibers, and a first housing. The second connector includes a plurality of second conductors, a plurality of second optical fibers, and a second housing. The first housing includes a first end face, and the second housing includes a second end face. Each leading end portion of the first conductors is exposed at the first end face, and each leading end portion of the second conductors is exposed at the second end face. Each first conductor and each second conductor are configured to be brought into contact with each other to achieve conduction, and each first optical fiber and each second optical fiber are configured to be optically coupled to each other in a non-contact state.

### CROSS REFERENCE TO RELATED APPLICATIONS

The present application claims priority based on Japanese Patent Application No. 2023-152737, filed on Sep. 20, 2023, the entire contents of which are incorporated herein by reference.

### TECHNICAL FIELD

The present disclosure relates to an opto-electrical connection system and an opto-electrical connector.

### BACKGROUND

JP2017-069166A discloses an electrical connector including a plurality of conductive wires arranged side-by-side.

### SUMMARY

A opto-electrical connection system according to an embodiment of the present disclosure includes a first connector and a second connector. The first connector includes a plurality of first conductors, a plurality of first optical fibers, and a first housing placing each leading end portion of the plurality of first conductors and each leading end portion of the plurality of first optical fibers therein. The second connector includes a plurality of second conductors, a plurality of second optical fibers, and a second housing placing each leading end portion of the plurality of second conductors and each leading end portion of the plurality of second optical fibers therein. The first housing includes a first end face configured to face the second housing, and the second housing includes a second end face configured to face the first housing. Each leading end portion of the plurality of first conductors is exposed at the first end face, and each leading end portion of the plurality of second conductors is exposed at the second end face. Each of the plurality of first conductors and each of the plurality of second conductors are configured to be brought into contact with each other to achieve conduction, and each of the plurality of first optical fibers and each of the plurality of second optical fibers are configured to be optically coupled to each other in a non-contact state, when the first connector is connected to the second connector.

### BRIEF DESCRIPTION OF THE DRAWINGS

FIG. 1 is a schematic perspective view illustrating an opto-electrical connector according to an embodiment;

FIG. 2 is an exploded perspective view of the opto-electrical connector illustrated in FIG. 1;

FIG. 3 is a schematic perspective view illustrating a sub-connector of the opto-electrical connector illustrated in FIG. 1;

FIG. 4 is a schematic perspective view illustrating a corresponding connector mating with the opto-electrical connector illustrated in FIG. 1;

FIG. 5 is an enlarged schematic cross-sectional view illustrating a connection system to connect the opto-electrical connector illustrated in FIG. 1 and the corresponding opto-electrical connector illustrated in FIG. 4;

FIG. 6 is a schematic cross-sectional view illustrating a state after both connectors are connected with each other, in the connection system illustrated in FIG. 5;

FIG. 7 is an enlarged cross-sectional view illustrating a region VII in the connection system illustrated in FIG. 6;

FIG. 8A is a schematic cross-sectional view illustrating a first modification of the connection system of the opto-electrical connectors and illustrates a state before connection, and FIG. 8B is a schematic cross-sectional view illustrating the first modification of the connection system of the opto-electrical connectors and illustrates a state after connection;

FIG. 9A is a schematic cross-sectional view illustrating a second modification of the connection system of the opto-electrical connectors and illustrates a state before connection, and FIG. 9B is a schematic cross-sectional view illustrating the second modification of the connection system of the opto-electrical connectors and illustrates a state after connection;

FIG. 10 is a perspective view illustrating a third modification of the connection system of the opto-electrical connectors;

FIG. 11 is an enlarged schematic cross-sectional view illustrating the connection system of the opto-electrical connectors illustrated in FIG. 10 and illustrates a state before connection;

FIG. 12 is a schematic cross-sectional view illustrating a state after connection in the connection system illustrated in FIG. 11; and

FIG. 13 is a schematic cross-sectional view illustrating a modification (a fourth modification) of the connection system illustrated in FIG. 11.

### DETAILED DESCRIPTION

### Problem to be Solved by Present Disclosure

In a connection system of the electrical connector described in JP2017-069166A, a plurality of conductive wires housed in the electrical connector are connected to electrode pads of a corresponding electrical connector through terminals and contact parts of different modes. In a case where the parts different from the form of the conductive wires are present in a conduction path as described above, the mismatch of a high-frequency characteristic impedance may occur in the parts. In addition, in the connection system of the electrical connector described in JP2017-069166A, only conductive wires are wired. Accordingly, there is a demand for improving transmission capability as an opto-electrical connector by replacing some of the conductive wires with the optical fibers. However, in a case where an opto-electrical connector in which some of conductive wires are simply replaced with optical fibers is brought into contact with a corresponding connector, a mating force required for the contact (conduction) between the conductive wires is different from a mating force required for the physical contact (PC) between the optical fibers. Therefore, it may be difficult to achieve the stable connection between the conductive wires and between the optical fibers.

### Effects of Present Disclosure

According to the present disclosure, it is possible to achieve the stability of conduction between conductors and the stability of optical coupling between optical fibers while reducing the mismatch of a high-frequency characteristic impedance.

### DESCRIPTION OF EMBODIMENTS OF PRESENT DISCLOSURE

First, contents of embodiments of the present disclosure are listed and described.
(1) An opto-electrical connection system according to an embodiment includes a first connector and a second connector. The first connector includes a plurality of first conductors, a plurality of first optical fibers, and a first housing placing each leading end portion of the plurality of first conductors and each leading end portion of the plurality of first optical fibers therein. The second connector includes a plurality of second conductors, a plurality of second optical fibers, and a second housing placing each leading end portion of the plurality of second conductors and each leading end portion of the plurality of second optical fibers therein. The first housing includes a first end face configured to face the second housing, and the second housing includes a second end face configured to face the first housing. Each leading end portion of the plurality of first conductors is exposed at the first end face, and each leading end portion of the plurality of second conductors is exposed at the second end face. Each of the plurality of first conductors and each of the plurality of second conductors are configured to be brought into contact with each other to achieve conduction, and each of the plurality of first optical fibers and each of the plurality of second optical fibers are configured to be optically coupled to each other in a non-contact state, when the first connector is connected to the second connector.

In this opto-electrical connection system, each leading end portion of the plurality of first conductors is exposed at the first end face, and each leading end portion of the plurality of second conductors is exposed at the second end face. Each of the plurality of first conductors and each of the plurality of second conductors are configured to be brought into contact with each other to achieve conduction. According to this connection system, there is no portion different from the form of a conductive wire in a conduction path, and thus it is possible to reduce the mismatch of a high-frequency characteristic impedance. In addition, according to this opto-electrical connection system, each of the plurality of first optical fibers and each of the plurality of second optical fibers are configured to be optically coupled to each other in a non-contact state. According to such a configuration, the optical fibers requiring a higher mating force than the connection between the conductors are optically coupled with a less force. Thus, the influence on the connection between the conductors can be reduced. According to this configuration, even though the configuration in which the conductors are connected to each other is employed, it is possible to achieve the stability of conduction between the conductors and the stability of optical coupling between the optical fibers. Therefore, this opto-electrical connection system can achieve the stability of conduction between the conductors and the stability of optical coupling between the optical fibers while reducing the mismatch of a high-frequency characteristic impedance.
(2) In the opto-electrical connection system according to (1), at least one optical element configured to optically couple corresponding optical fibers to each other may be provided between each of the plurality of first optical fibers and each of the plurality of second optical fibers. According to this aspect, the optical fibers can be stably coupled with high coupling efficiency.
(3) In the opto-electrical connection system according to (1), an air gap may be provided between each leading end of the plurality of first optical fibers and each leading end of the plurality of second optical fibers. The air gap may have a width of 50 μm or less. According to this aspect, the optical fibers can be stably coupled in a non-contact manner by employing the simple configuration.
(4) In the opto-electrical connection system according to (3), each leading end of each first optical fiber may include a first leading end face inclined with respect to a plane orthogonal to a longitudinal direction in which each first optical fiber extends, and each leading end of each second optical fiber may include a second leading end face inclined with respect to a plane orthogonal to a longitudinal direction in which each second optical fiber extends. In this connection system, the first leading end face may face the second leading end face when the first connector is connected to the second connector. According to this aspect, the optical fibers can be stably coupled with each other in a non-contact manner by employing the simple configuration.
(5) In the opto-electrical connection system according to any one of (1) to (4), each leading end of at least one of the plurality of first optical fibers or the plurality of second optical fibers may be located at an inner side than an end face of the first housing or the second housing placing each leading end therein. According to this aspect, since the optical fibers are not physically in contact with each other, interference in the connection between the conductors is prevented. Therefore, conduction between the conductors can be more reliably achieved.
(6) The opto-electrical connection system according to any one of (1) to (5) may further include a spacer located between the first end face of the first housing and the second end face of the second housing. According to this aspect, it is possible to reliably define the separation distance between the housings by the spacer, and to accurately perform the optical coupling between the optical fibers in a non-contact manner.
(7) In the opto-electrical connection system according to any one of (1) to (6), the first connector may include a first electrical sub-connector placing each leading end portion of the plurality of first conductors therein and a first optical sub-connector placing the plurality of first optical fibers therein. The second connector may include a second electrical sub-connector placing each leading end portion of the plurality of second conductors therein and a second optical sub-connector placing the plurality of second optical fibers therein. In this connection system, the first electrical sub-connector may be configured to be connected to the second electrical sub-connector, and the first optical sub-connector may be configured to be connected to the second optical sub-connector. According to this aspect, since the electrical sub-connectors are connected to each other and the optical sub-connectors are connected to each other, the connection modes in the respective cases do not interfere with each other. Therefore, the connection between the conductors can be further stabilized, and the connection between the optical fibers can be further stabilized.
(8) In the opto-electrical connection system according to (7), the first electrical sub-connector may include a first guide pin, and the second electrical sub-connector may include a first guide hole corresponding to the first guide pin. The first optical sub-connector may include a second guide pin, and the second optical sub-connector may include a second guide hole corresponding to the second guide pin. In this connection system, the first electrical sub-connector may be positioned with respect to the second electrical sub-connector by inserting the first guide pin into the first guide hole. The first optical sub-connector may be positioned with respect to the second optical sub-connector by inserting the second guide pin into the second guide hole. According to this aspect, the conductive wires are connected with higher accuracy, and more reliable conduction can be achieved. In addition, the optical fibers are connected with higher accuracy, and the coupling efficiency can be further enhanced.
(9) In the opto-electrical connection system according to (7) or (8), the first electrical sub-connector may be configured to movable relative to the first optical sub-connector, and the second electrical sub-connector may be configured to be movable relative to the second optical sub-connector. According to this aspect, since the connection between the conductive wires and the connection between the optical fibers can be performed independently of each other, the connection between the conductors can be further stabilized, and the connection between the optical fibers can be further stabilized.
(10) In the opto-electrical connection system according to any one of (1) to (9), the first connector and the second connector may be configured to be couplable such that a first longitudinal direction in which the plurality of first conductors extend intersects with a second longitudinal direction in which the plurality of second conductors extend. According to this aspect, it is possible to provide a connection system with a high degree of freedom in design.
(11) In the opto-electrical connection system according to (10), the first end face of the first housing may include an inclination region inclined with respect to a plane orthogonal to the first longitudinal direction and a planar region extending along the plane orthogonal to the first longitudinal direction. The plurality of first conductors may be exposed at the inclination region. The plurality of first optical fibers may be located in a portion corresponding to the planar region. According to this aspect, in the connection system in which the longitudinal directions intersect with each other, the conductors can be connected to each other more reliably, and the optical fibers can be connected to each other more reliably.
(12) In the opto-electrical connection system according to (10) or (11), at least one optical element configured to optically couple corresponding optical fibers to each other may be provided between each of the plurality of first optical fibers and each of the plurality of second optical fibers. The optical element may be configured to bend an optical path between the optical fibers being optically coupled to each other. According to this aspect, in the connection system in which the longitudinal directions intersect with each other, the optical fibers can be optically coupled to each other more reliably.
(13) An opto-electrical connector according to an embodiment includes a plurality of conductors, a plurality of optical fibers, and a housing placing each leading end portion of the plurality of conductors and each leading end portion of the plurality of optical fibers therein. The plurality of conductors are exposed at an end face of the housing. Each leading end of the plurality of optical fibers is located at an inner side than the end face of the housing such that the plurality of optical fibers are optically coupled to corresponding optical fibers in a non-contact state. According to this opto-electrical connector, there is no portion different from the form of the conductive wire in the conduction path when the opto-electrical connector is connected to a corresponding connector. Thus, it is possible to reduce the mismatch of a high-frequency characteristic impedance. In addition, according to this opto-electrical connector, similarly to the connection system of the above aspects, the optical fibers are optically coupled to each other with a less force when the opto-electrical connector is connected to the corresponding connector. Thus, it is possible to reduce the influence on the connection between the conductors. According to this opto-electrical connector, even though the configuration in which the conductors are connected to each other is employed, it is possible to achieve the stability of conduction between the conductors and the stability of optical coupling between the optical fibers. Therefore, this opto-electrical connector can achieve the stability of conduction between the conductors and the stability of optical coupling between the optical fibers while reducing the mismatch of a high-frequency characteristic impedance.
(14) The opto-electrical connector according to (13) may further include an optical element configured to optically couple each of the plurality of optical fibers to each of the corresponding optical fibers. According to this aspect, the optical fibers can be stably coupled with high coupling efficiency.
(15) In the opto-electrical connector according to (13) or (14), the housing may include a plurality of first housing holes respectively placing the plurality of conductors therein, and a plurality of second housing holes respectively placing the plurality of optical fibers therein. The opto-electrical connector may further include a positioning structure configured to position each of the plurality of optical fibers with respect to each of the corresponding optical fibers. In this case, accurate positioning can be performed with respect to the corresponding optical connector.

### DETAILS OF EMBODIMENT OF PRESENT DISCLOSURE

Specific examples of an opto-electrical connection system and an opto-electrical connector according to an embodiment of the present disclosure will be described below with reference to the drawings. In the following description, the same reference signs will be used for the same elements or elements having the same functions, and the description will not be repeated to avoid redundancy. Note that, the present invention is not limited to these examples, indicated by the claims, and intended to include all modifications within the meaning and scope equivalent to the claims.

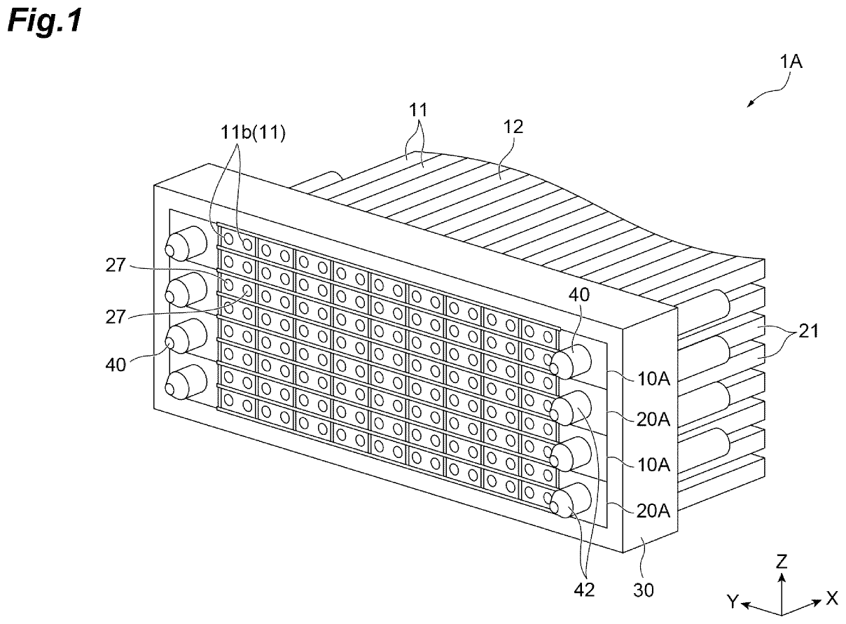

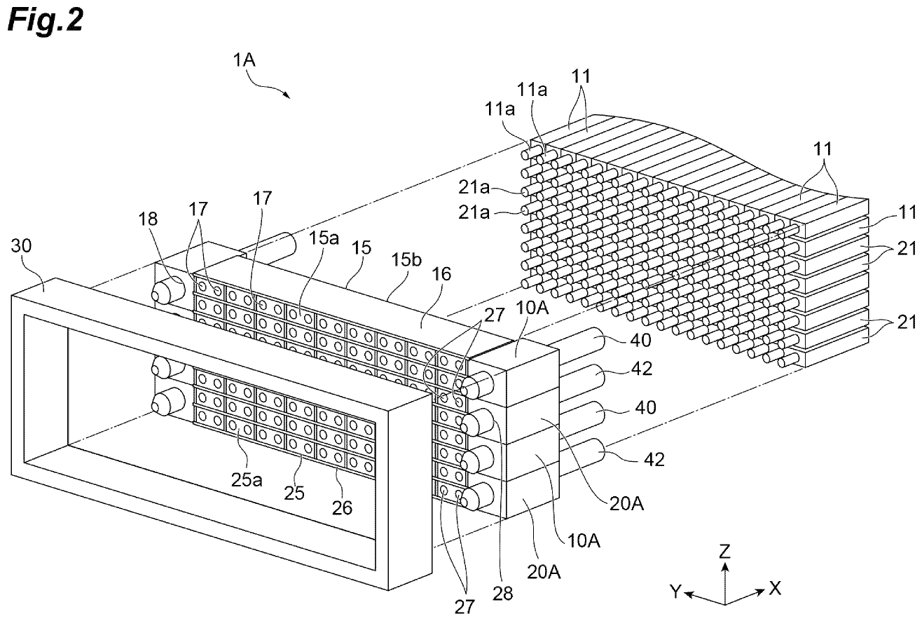

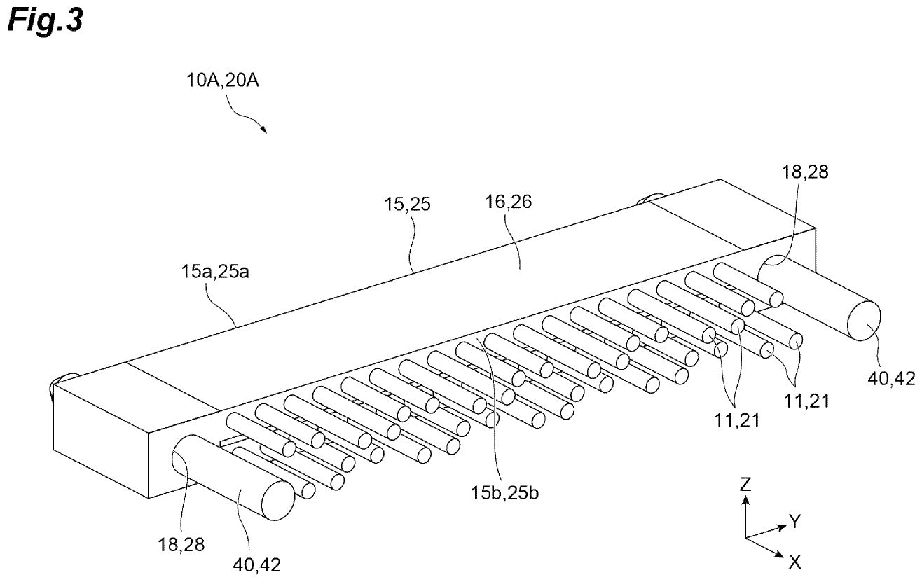

FIG. 1 is a schematic perspective view illustrating an opto-electrical connector according to an embodiment. FIG. 2 is an exploded perspective view of the opto-electrical connector illustrated in FIG. 1. FIG. 3 is a schematic perspective view illustrating a sub-connector included in the opto-electrical connector illustrated in FIG. 1. As illustrated in FIGS. 1 to 3, an opto-electrical connector 1A (hereinbelow, a first connector, also referred to as a “connector 1A”) includes two sub-connectors 10A (first electrical sub-connector), two sub-connectors 20A (first optical sub-connector), and a frame 30. The two sub-connectors 10A and two sub-connectors 20A are fitted into the frame 30. The number of sub-connectors included in the connector 1A is not limited to two for each connector, and the configuration in which one sub-connector 10A and one sub-connector 20A are provided may be adopted, or the configuration in which three or more sub-connectors 10A and 20A are provided may be adopted. The number of sub-connectors 10A and the number of sub-connectors 20A may not be the same, and for example, the connector 1A may include one sub-connector 10A and three sub-connectors 20A.

Each of the sub-connectors 10A is a connector for achieving electrical conduction and includes a plurality of conductive wires 11 (a first conductor and a second conductor), a housing 15 (a first housing and a second housing), and a pair of guide pins 40. The plurality of conductive wires 11 each extend along the X direction and are arranged side by side in the Y direction in each sub-connector 10A. The housing 15 places each of leading end portions 11a of such a plurality of conductive wires 11 therein to hold these portions 11a.

The plurality of conductive wires 11 are members for transmitting electrical power or electrical signals. Each conductive wire 11 may be, for example, a signal wire or a ground wire. In an example, a pair of signal wires and a pair of ground wires may be alternately arranged along the Y direction. The pair of signal wires adjacent to each other may carry currents of opposite phases to each other and may transmit signals by differential signaling for transmitting signals using a potential difference between the pair of signal lines. Each of the conductive wires 11 includes, for example, a conductor made of metal such as copper. Each of the conductive wires 11 may be an insulated electrical wire with a conductor covered with an insulator or a bare electrical wire with a conductor exposed as it is. As an example, the plurality of conductive wires 11 may be integrated by a covering member 12 to form a flexible flat cable (FFC) (see FIGS. 1 and 2). In FIG. 3, the description of the covering member 12 is omitted. The covering member 12 covers each of the plurality of conductive wires 11 excluding a leading end portion 11a and a tailing end portion. The covering member 12 is formed of, for example, a resin such as polyester. The distance between individual conductors of the plurality of conductive wires 11 (distance between the centers) is, for example, 0.6 mm.

The housing 15 is a member to hold each leading end portion 11a of the plurality of conductive wires 11, and has a rectangular parallelepiped main body portion 16. The housing 15 is formed of, for example, a resin such as polyphenylene sulfide (PPS) or other resins. The main body portion 16 of the housing 15 is provided with a plurality of housing holes 17 and a pair of guide holes 18.

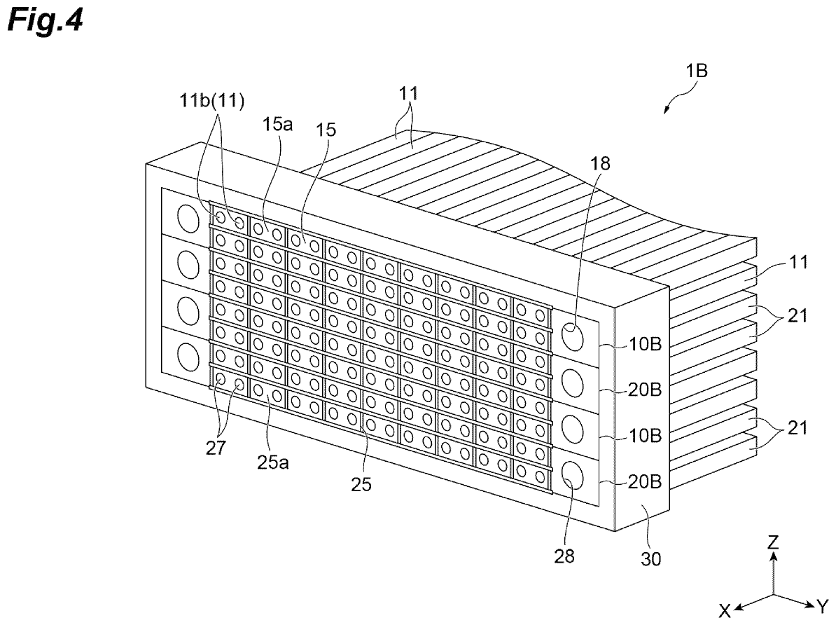

Each housing hole 17 is a hole extending along the X direction to penetrate the main body portion 16 of the housing 15. Each housing hole 17 is open at a front end face 15a (first end face, second end surface) and a rear end face 15b of the housing 15. The plurality of housing holes 17 respectively place the plurality of conductive wires 11 therein. As an example, eighteen housing holes 17 may be arranged in two rows along the Z direction, the eighteen housing holes 17 in each row being arranged along the Y direction. The inner diameter of each housing hole 17 is the same as or slightly greater than the outer diameter of a conductor (leading end portion 11a) of each conductive wire 11. The leading end portion 11a of each conductive wire 11 is placed and held in each housing hole 17. Each leading end portion 11a of the plurality of conductive wires 11 is exposed through each of the plurality of housing holes 17 at the front end face 15a. Specifically, each leading end face 11b (first end face, second end face) of the plurality of conductive wires 11 are flush with the front end face 15a. In a case where the connector 1A is connected to an opto-electrical connector 1B (see FIG. 4, hereinafter, referred to as a “connector 1B”) described later, each of the plurality of conductive wires 11 arranged in this manner is brought into contact with and conducts with each of a plurality of conductive wires 11 of the connector 1B.

The pair of guide holes 18 are holes penetrating the housing 15 along the X direction, and are formed at both ends of the housing 15 to sandwich the plurality of housing holes 17 therebetween in the Y direction. Each of the guide holes 18 is configured to enable each of the guide pins 40 to be press-fitted, and the pair of guide pins 40 are press-fitted into the pair of guide holes 18, respectively. The cross-sectional shapes of each guide hole 18 and each guide pin 40 are, for example, circular. The inner diameter of each of the pair of guide holes 18 is formed to be greater than the inner diameter of each of the housing holes 17. By using such guide holes 18 and guide pins 40, the housing 15 of the connector 1A can be positioned with respect to the housing 15 of the connector 1B (see FIG. 4) described later when the connector 1A is connected to the connector 1B.

Each of the sub-connectors 20A includes a plurality of optical fibers 21, a housing 25, and a pair of guide pins 42. The plurality of optical fibers 21 each extend along the X direction and are arranged side by side in the Y direction in each of the sub-connectors 20A. The housing 25 places each leading end portion 21a of such a plurality of optical fibers 21 therein to hold portions 21a.

The plurality of optical fibers 21 are members for transmitting optical signals. Each of the optical fibers 21 includes a bare optical fiber and a resin coating that covers the bare optical fiber. At the leading end portion 21a of each optical fiber 21, the resin coating is removed, and the bare optical fiber is exposed. The plurality of optical fibers 21 may be a taped fiber. The distance between individual bare optical fibers of the plurality of optical fibers 21 (distance between the centers) is, for example, 0.6 mm.

The housing 25 is a member to hold each leading end portion 21a of the plurality of optical fibers 21, and includes a rectangular parallelepiped main body portion 26 similar to the housing 15. The housing 25 may be formed of, for example, a resin such as PPS. The main body portion 26 of the housing 25 is provided with a plurality of housing holes 27 and a pair of guide holes 28.

Each housing hole 27 is a hole extending along the X direction to penetrate the main body portion 26 of the housing 25. Each housing hole 27 is open at a front end face 25a and a rear end face 25b of the housing 25. The plurality of housing holes 27 respectively places the plurality of optical fibers 21 therein. As an example, eighteen housing holes 27 may be arranged in two rows along the Z direction, the eighteen housing holes 27 in each row being arranged along the Y direction. The inner diameter of each of the housing holes 27 is the same as or slightly greater than the outer diameter of the bare optical fiber (leading end portion 21a) of each optical fiber 21. The leading end portion 21a of each optical fiber 21 is placed and held in each housing hole 27. Each leading end portion 21a of the plurality of optical fibers 21 is located at the inner side than the front end face 25a of the housing 25. Details will be described later. Each of the plurality of optical fibers 21 arranged in this manner is optically coupled to the plurality of optical fibers 21 of the connector 1B described later in a case where the connector 1A is connected to a connector 1B. The optical coupling between the optical fibers 21 is performed in a non-contact state although details will be described later.

The pair of guide holes 28 are holes penetrating the housing 25 along the X direction similar to the guide holes 18, and are formed at both ends of the housing 25 to sandwich the plurality of housing holes 27 therebetween in the Y direction. Each of the guide holes 28 is configured to enable each of the guide pins 42 to be press-fitted, and the pair of guide pins 42 are press-fitted into the pair of guide holes 28, respectively. By using such guide holes 28 and guide pins 42, the housing 25 of the connector 1A can be positioned with respect to the housing 25 of the connector 1B described later when the connector 1A is connected to the connector 1B.

Next, an opto-electrical connector, which is an example of a corresponding connector that is connected to the above-described connector 1A to form a connection system, will be described with reference to FIG. 4. FIG. 4 is a schematic perspective view illustrating an opto-electrical connector configured to be fittable to the opto-electrical connector 1A. As illustrated in FIG. 4, the opto-electrical connector 1B (second connector) includes two sub-connectors 10B (second electrical sub-connector), two sub-connectors 20B (second optical sub-connector), and a frame 30. The sub-connectors 10B are different from the sub-connectors 10A in that the guide pins 40 are not provided, but other configurations are the same as those of the sub-connectors 10A. Similarly, the sub-connectors 20B are different from the sub-connectors 20A in that the guide pins 42 are not provided, but other configurations are the same as those of the sub-connectors 20A. The connector 1A is connected to the connector 1B such that the front end faces thereof face each other to form a connection system. At this time, the guide pins 40 and 42 of the connector 1A are respectively inserted (press-fitted) into the corresponding guide holes 18 and 28 of the connector 1B, thereby adjusting the mutual positional relationship. Note that the connector 1B may be mounted on a substrate (not illustrated) or other components.

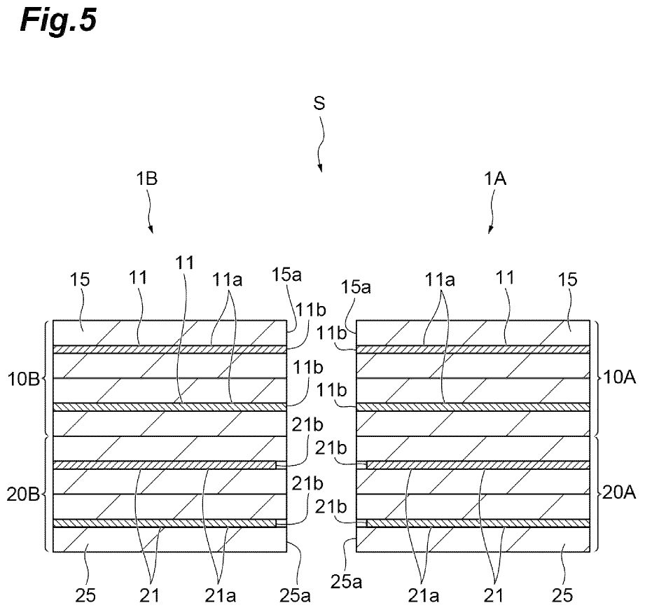

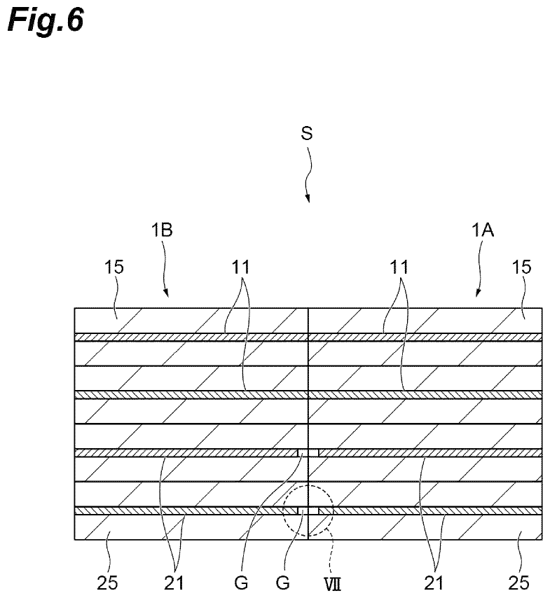

Next, a connection state of the conductive wires 11 and a connection state of the optical fibers 21 when the connector 1A is connected to the connector 1B, will be described with reference to FIGS. 5 and 6. As illustrated in FIG. 5, in a connection system S of the opto-electrical connectors, each of the connectors 1A and 1B has a configuration in which leading end portions 11a of conductive wires 11 are exposed at the front end face 15a of the housing 15 housing the conductive wires 11. For example, each leading end face 11b of the plurality of conductive wires 11 is configured to be flush with the front end face 15a. On the other hand, in each of the connectors 1A and 1B, a leading end face 21b of each optical fiber 21 is configured to be slightly recessed inward from the front end face 25a of the housing 25 housing the optical fiber 21, and is configured not to be exposed at the front end face 25a. In a case where the connector 1A and the connector 1B having such configurations are connected to each other, as illustrated in FIG. 6, each of the conductive wires 11 of the connector 1A and each of the conductive wires 11 of the connector 1B are brought into contact with each other to achieve conduction. On the other hand, each optical fiber 21 of the connector 1A and each optical fiber 21 of the connector 1B are configured to be optically coupled to each other in a non-contact state. In other words, an air gap G is formed between leading ends of the optical fibers 21. In such a case where the width of the air gap G (width depending on a connection method) is tiny, optical coupling can be performed even though the optical fibers are not in contact with each other. Therefore, in the present embodiment, leading end positions of the optical fibers 21 of each of the connectors 1A and 1B are set such that the width of the air gap G is, for example, 50 μm or less. The air gap G may be less than or equal to 40 μm, may be less than or equal to 30 μm, or may be less than or equal to 20 μm.

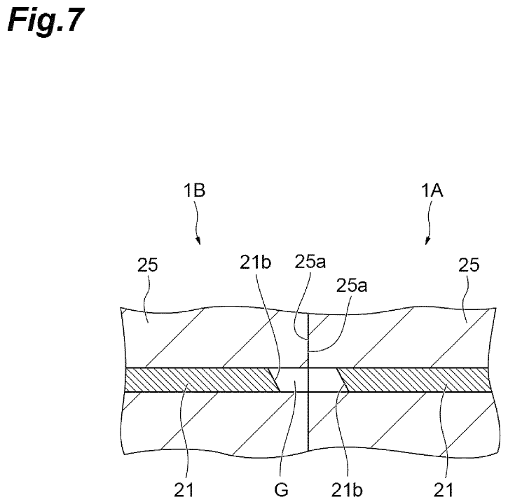

FIG. 7 is an enlarged cross-sectional view of a region VII illustrated in FIG. 6. In the optical fibers 21 that perform optical coupling in the non-contact state as described above, the leading end faces 21b may be inclined as illustrated in FIG. 7. The leading end face 21b of each optical fiber 21 placed in the connector 1A and the leading end face 21b of each optical fiber 21 placed in the connector 1B face each other, and as an example, leading end faces 21b and 21b facing each other may be formed to be parallel to each other. Note that the inclination angle of each leading end face 21b may be, for example, 3° or greater and 10° or smaller with respect to a plane orthogonal to a longitudinal direction (optical axis) in which each optical fiber 21 extends. As an example, the above-described inclination angle of the leading end face 21b of each optical fiber 21 is 8°.

### (First Modification)

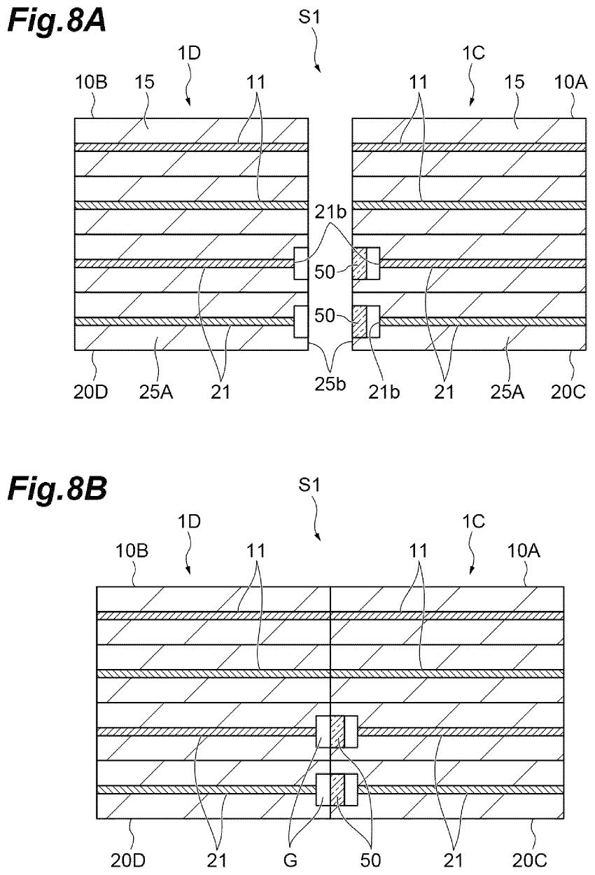

Next, a first modification of the connection system of the opto-electrical connector will be described with reference to FIGS. 8A and 8B. FIG. 8A is a schematic cross-sectional view illustrating a first modification of the connection system of the opto-electrical connectors and illustrates a state before connection, and FIG. 8B is a schematic cross-sectional view illustrating the first modification of the connection system of the opto-electrical connectors and illustrates a state after connection. As illustrated in FIGS. 8A and 8B, a connection system S1 of an opto-electrical connector according to the first modification includes an opto-electrical connector 1C (hereinbelow, a first connector, also referred to as a “connector 1C”) and an opto-electrical connector 1D (hereinbelow, a second connector, also referred to as a “connector 1D”). The connector 1C and the connector 1D include sub-connectors 10A and 10B similarly to those of the connector 1A and the connector 1B. That is, a connection system of a plurality of conductive wires 11 is similar to that of the above-described embodiment, and leading end faces 11b of the plurality of conductive wires 11 are exposed at a front end face 15a of a housing 15.

On the other hand, sub-connectors 20C and 20D each include a plurality of optical fibers 21 and a housing 25A placing the plurality of optical fibers 21 therein. In the sub-connectors 20C and 20D, similarly to the above-described embodiment, each leading end face 21b of the plurality of optical fibers 21 is formed to be located inward from a front end face 25a of the housing 25A. Furthermore, in this first modification, the sub-connectors 20C of the connector 1C are provided with optical elements 50 facing the leading end faces 21b of the individual optical fibers 21. Each optical element 50 is, for example, an optical lens such as a condenser lens. At least one optical element 50 may be provided in a conduction path in a case where each optical fiber 21 of the sub-connectors 20C is optically coupled to each optical fiber 21 of the sub-connectors 20D, and two or more optical elements 50 (for example, lenses) may be provided in the conduction path. According to such a configuration, the optical fibers 21 can be stably coupled with high coupling efficiency. The optical element 50 that performs optical coupling in a non-contact state may be provided in at least one of the connector 1C or the connector 1D, but may be provided in both of the connectors 1C and 1D. Even in a case where such an optical element 50 is provided, an air gap G is provided at the tip of the leading end portion 21a of the optical fibers 21.

### (Second Modification)

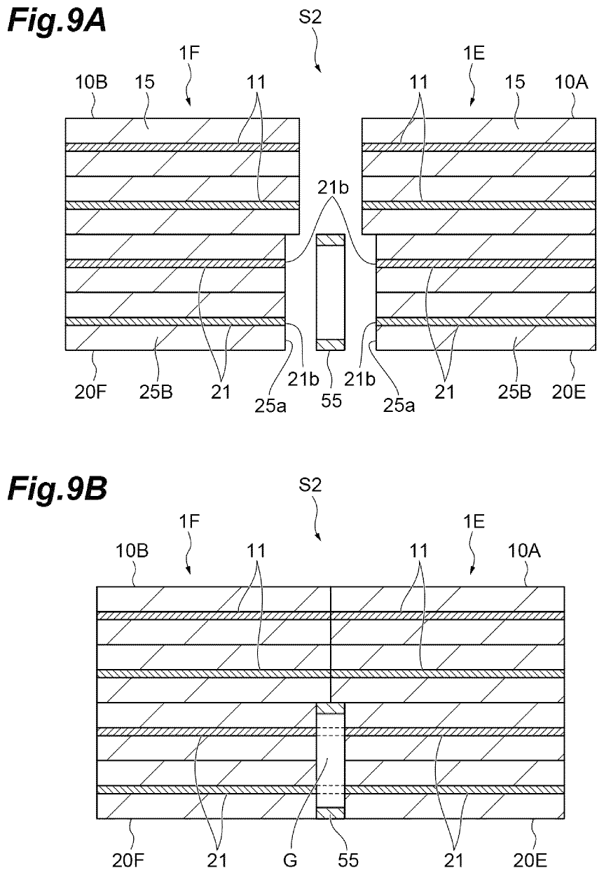

Next, a second modification of the connection system of the opto-electrical connector will be described with reference to FIGS. 9A and 9B. FIG. 9A is a schematic cross-sectional view illustrating a second modification of the connection system of the opto-electrical connector and illustrates a state before connection, and FIG. 9B is a schematic cross-sectional view illustrating the second modification of the connection system of the opto-electrical connector and illustrates a state after connection. As illustrated in FIGS. 9A and 9B, a connection system S2 of an opto-electrical connector according to the second modification includes an opto-electrical connector 1E (hereinbelow, a first connector, also referred to as a “connector 1E”) and an opto-electrical connector 1F (hereinbelow, a second connector, also referred to as a “connector 1F”). The connector 1E and the connector 1F include sub-connectors 10A and 10B similarly to those of the connector 1A and the connector 1B. That is, a connection system of a plurality of conductive wires 11 is similar to that of the above-described embodiment, and leading end faces 11b of the plurality of conductive wires 11 are exposed at a front end face 15a of a housing 15.

On the other hand, sub-connectors 20E and 20F each include a plurality of optical fibers 21 and a housing 25B placing the plurality of optical fibers 21 therein. In these sub-connectors 20E and 20F, in contrast to the above-described embodiment, each leading end face 21b of the plurality of optical fibers 21 is formed to be exposed at a front end face 25a of the housing 25B. However, in this second modification, a frame-shaped spacer 55 is further provided between the connector 1E and the connector 1F. The spacer 55 is sandwiched to be located between the front end face 25a of the housing 25B of the connector 1E and the front end face 25a of the housing 25B of the connector 1F, and maintains the plurality of optical fibers 21 placed in the connector 1E and the plurality of optical fibers 21 placed in the connector 1F to be in a non-contact state. In other words, it is possible to reliably define the separation distance between the housings by the spacer 55, and to accurately perform the optical coupling between the optical fibers in a non-contact manner. The spacer 55 is a member configured to optically couple both optical fibers in a non-contact manner, and has a frame-shaped hollow. Since the spacer 55 is a member configured to define the air gap G between the optical fibers 21, the thickness thereof may be 50 μm or less, 40 μm or less, 30 μm or less, or 20 μm or less. In the example illustrated in FIGS. 9A and 9B, the leading end face 21b of each optical fiber 21 is flush with the front end face 25a of the housing 25B, but the present disclosure is not limited thereto. For example, the spacer 55 may be provided in an arrangement in which the leading end face 21b of each optical fiber 21 is located at the inner side than the front end face 25a of the housing 25B.

### (Third Modification)

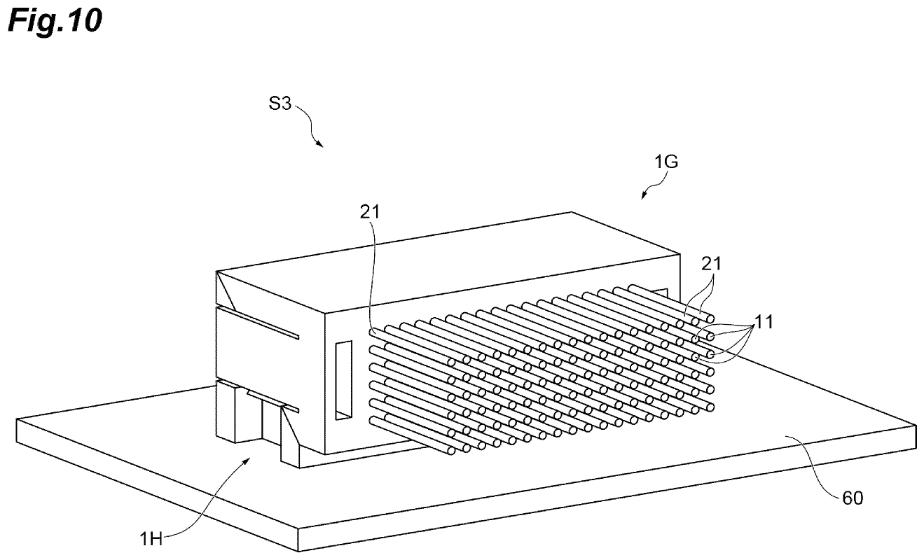

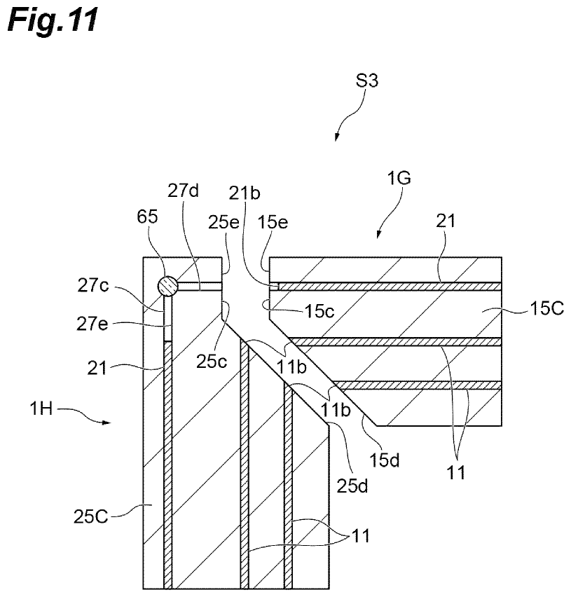

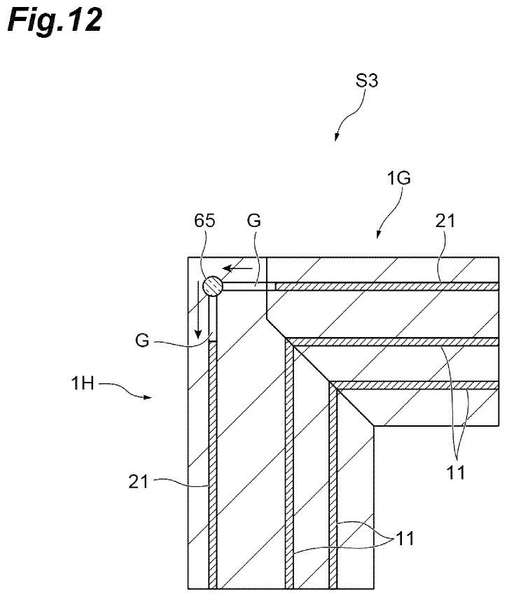

Next, a third modification of the connection system of the opto-electrical connectors will be described with reference to FIGS. 10, 11, and 12. FIG. 10 is a perspective view illustrating the third modification of the connection system of the opto-electrical connectors. FIG. 11 is an enlarged schematic cross-sectional view illustrating the connection system of the opto-electrical connectors illustrated in FIG. 10 and illustrates a state before connection. FIG. 12 is a schematic cross-sectional view illustrating a state after connection in the connection system illustrated in FIG. 11. As illustrated in FIG. 10, a connection system S3 of opto-electrical connectors according to the third modification includes an opto-electrical connector 1G (hereinbelow, a first connector, also referred to as a “connector 1G”) and an opto-electrical connector 1H (hereinbelow, a second connector, also referred to as a “connector 1H”). In this connection system S3, the connector 1G and the connector 1H are connected such that a direction in which conductive wires 11 and optical fibers 21 placed in the connector 1G extend and a direction in which conductive wires 11 and optical fibers 21 placed in the connector 1H extend are orthogonal (intersect) to each other. In this modification, the connection direction is different from that of the above-described embodiment and the like. The connector 1H may be mounted on a substrate 60.

Here, the connection between the conductive wires 11 and the connection between the optical fibers 21 in the third modification will be described with reference to FIGS. 11 and 12. As illustrated in FIGS. 11 and 12, the connector 1G includes a plurality of conductive wires 11, a plurality of optical fibers 21, and a housing 15C placing each leading end portion 11a of the plurality of conductive wires 11 and each leading end portion 21a of the plurality of optical fibers 21 therein to hold them. In FIGS. 11 and 12, part of the conductive wires 11 and optical fibers 21 are illustrated, and the others are omitted. The housing 15C of the connector 1G has a front end face 15c. The front end face 15c includes an inclination region 15d inclined with respect to a plane orthogonal to the longitudinal direction (first longitudinal direction) in which the conductive wires 11 and the optical fibers 21 extend, and a planar region 15e extending along the orthogonal plane. The plurality of conductive wires 11 is exposed in the inclination region 15d of the housing 15C. On the other hand, the plurality of optical fibers 21 are located at a portion corresponding to the planar region 15e of the housing 15C, and formed to be located inward slightly from the planar region 15e.

The connector 1H serving as a corresponding connector with the connector 1G includes a plurality of conductive wires 11, a plurality of optical fibers 21, and a housing 25C placing each leading end portion 11a of the plurality of conductive wires 11 and each leading end portion 21a of the plurality of optical fibers 21 therein to hold them, similar to the connector 1G. In the third modification, since each conductive wire and each optical fiber are connected to intersect each other (for example, to form an L shape), the longitudinal direction in which the conductive wires 11 of the connector 1H extend and the longitudinal direction in which the optical fibers 21 of the connector 1H extend are different from the longitudinal directions in which the conductive wires 11 and the optical fibers 21 of the connector 1G extend, and as an example, both are orthogonal to each other. Such a housing 25C of the connector 1H has a front end face 25c. The front end face 25c is a face corresponding to the front end face 15c and includes an inclination region 25d inclined with respect to a plane orthogonal to the longitudinal direction (second longitudinal direction) in which the conductive wires 11 and the optical fibers 21 extend, and a planar region 25e extending along the orthogonal plane. The plurality of conductive wires 11 is exposed in the inclination region 25d of the housing 25C. On the other hand, the plurality of optical fibers 21 are located at a portion corresponding to the planar region 25e of the housing 25C, and formed to be located inward from the planar region 25e.

In the third modification, a housing hole 27c for placing each optical fiber 21 in the housing 25C has an L shape. The housing hole 27c includes a first portion 27d extending in the same direction as the direction in which the optical fibers 21 of the connector 1G extend and a second portion 27e extending in the same direction as the direction in which the optical fibers 21 of the connector 1H extend. The first portion 27d and the second portion 27e close to the first portion 27d remain as voids, and the optical fiber 21 is not placed. On the other hand, an optical element 65 configured to bend the direction of an optical signal is provided between the first portion 27d and the second portion 27e. As such an optical element 65, for example, an optical mirror or a prism changing an optical path can be used. By employing such an optical element 65, the individual optical fibers 21 are optically coupled to each other in a non-contact state when the connector 1G is connected to the connector 1H as illustrated in FIG. 12. Since both the conductive wire 11 of the connector 1G and the conductive wire of the connector 1H are exposed, conduction is established by connecting the connector 1G and the connector 1H.

### (Fourth Modification)

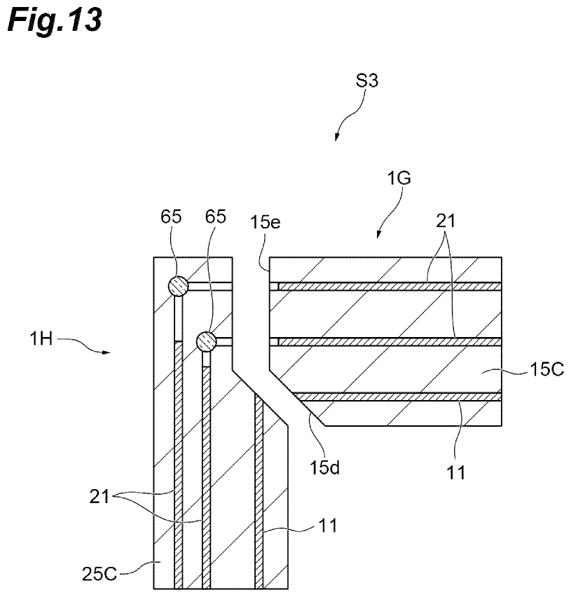

Next, a fourth modification of the connection system of the opto-electrical connector will be described with reference to FIG. 13. FIG. 13 is a schematic cross-sectional view illustrating a modification (a fourth modification) of the connection system illustrated in FIG. 11. The fourth modification is a modification in which the number of optical fibers is increased in the connection system illustrated in the third modification. In the fourth modification, the number of optical fibers 21 is increased to be formed in two rows. On the other hand, the portion of the inclination region 15d where the conductive wires 11 are exposed is reduced. Thus, in the connection system according to the fourth modification, the connector 1G can be shortened. In a case where the conductive wires and the optical fibers are connected in an L shape as in the third modification and the fourth modification, the region where the conductive wires 11 are exposed is not limited to the inclined region, and may be a planar region. In this case, the planar region where the optical fibers are located may be different from the planar region where the conductive wires 11 are located (exposed), or these planar regions may be formed in a stair shape when viewed from a cross-sectional view.

As described above, in the connection system S of the opto-electrical connectors according to the present embodiment, each leading end portion 11a of the plurality of conductive wires 11 in the connector 1A is exposed at the front end face, and each leading end portion 11a of the plurality of conductive wires 11 in the connector 1B is exposed at the front end face. Each of the plurality of conductive wires 11 of the connector 1A and each of the plurality of conductive wires 11 of the connector 1B are configured to be brought into contact with each other to achieve conduction. According to this connection system, there is no portion different from the form of a conductive wire in a conduction path, and it is possible to reduce the mismatch of a high-frequency characteristic impedance. In addition, according to this connection system S of the opto-electrical connectors, each of the plurality of optical fibers 21 of the connector 1A and each of the plurality of optical fibers 21 of the connector 1B are configured to be optically coupled to each other in a non-contact state. According to such a configuration, the optical fibers requiring a higher mating force than the connection between the conductors are optically coupled with a less force. Thus, the influence on the connection between the conductors can be reduced. According to this connection system S, even though the configuration in which the conductors are connected to each other is employed, it is possible to achieve the stability of conduction between the conductors and the stability of optical coupling between the optical fibers. Therefore, the connection system S of the opto-electrical connectors can achieve the stability of conduction between the conductors and the stability of optical coupling between the optical fibers while reducing the mismatch of a high-frequency characteristic impedance.

In the connection system S of the opto-electrical connector according to the present embodiment, the air gap is provided between each leading end of the plurality of optical fibers 21 of the connector 1A and each leading end of the plurality of optical fibers 21 of the connector 1B. The air gap has a width of 50 μm or less. According to such a configuration, the optical fibers can be stably coupled in a non-contact manner by adopting the simple configuration.

In the connection system S of the opto-electrical connectors according to the present embodiment, each leading end of the optical fibers 21 of the connector 1A and each leading end of the optical fibers 21 of the connector 1B are respectively located at an inner side than the front end faces 15a and 25a of the housings 15 and 25 in which each leading end is housed. According to this configuration, since the optical fibers are not physically in contact with each other, interference in the connection between the conductors is prevented. Therefore, conduction between the conductors can be more reliably achieved.

In the connection system S of the opto-electrical connectors according to the present embodiment, the connector 1A includes the sub-connectors 10A placing each leading end portion of the plurality of conductive wires 11 therein and the sub-connectors 20A placing the plurality of optical fibers 21 therein. The connector 1B includes the sub-connectors 10B placing each leading end portion of the plurality of conductive wires 11 therein and the sub-connectors 20B placing the plurality of optical fibers 21 therein. In the connection system S, the sub-connectors 10A and the sub-connectors 10B are connected to each other, and the sub-connectors 20A and the sub-connectors 20B are connected to each other. According to this configuration, since the sub-connectors 10A and 10B for the conductive wires are connected to each other, and the sub-connectors 20A and 20B for the optical fibers are connected to each other, the connection modes in the respective cases do not interfere with each other. Therefore, the connection between the conductors can be further stabilized, and the connection between the optical fibers can be further stabilized.

In the connection system S of the opto-electrical connectors according to the present embodiment, the sub-connectors 10A include guide pins 40, and the sub-connectors 10B include guide holes 18 corresponding to the guide pins 40. The sub-connectors 20A include guide pins 42, and the sub-connector 20B include guide holes 28 corresponding to the guide pins 42. In this connection system, each of the sub-connectors 10A is positioned with respect to each of the sub-connectors 10B by inserting the guide pins 40 into the guide holes 18 of each of the sub-connectors 10B. Each of the sub-connectors 20A is positioned with respect to each of the sub-connectors 20B by inserting the guide pins 42 into the guide holes 28 of each of the sub-connectors 20B. Accordingly, the conductive wires are connected with higher accuracy, and more reliable conduction can be achieved. In addition, the optical fibers are connected with higher accuracy, and the coupling efficiency can be further enhanced.

In the connection system S of the opto-electrical connector according to the present embodiment, the sub-connectors 10A and the sub-connectors 10B are configured to be movable relative to the sub-connectors 20A and the sub-connectors 20B. According to this configuration, since the connection between the conductive wires and the connection between the optical fibers can be performed independently of each other, the connection between the conductors can be further stabilized, and the connection between the optical fibers can be further stabilized.

The functions and effects of the connection system S described above can be similarly achieved in the connection systems S1 to S3 according to the first modification to the fourth modification.

What is claimed is:

1. An opto-electrical connection system, comprising:
a first connector including a plurality of first conductors, a plurality of first optical fibers, and a first housing placing each leading end portion of the plurality of first conductors and each leading end portion of the plurality of first optical fibers therein; and
a second connector including a plurality of second conductors, a plurality of second optical fibers, and a second housing placing each leading end portion of the plurality of second conductors and each leading end portion of the plurality of second optical fibers therein,
wherein the first housing includes a first end face configured to face the second housing, and the second housing includes a second end face configured to face the first housing,
wherein each leading end portion of the plurality of first conductors is exposed at the first end face, and each leading end portion of the plurality of second conductors is exposed at the second end face, and,
wherein each of the plurality of first conductors and each of the plurality of second conductors are configured to be brought into contact with each other to achieve conduction, and each of the plurality of first optical fibers and each of the plurality of second optical fibers are configured to be optically coupled to each other in a non-contact state, when the first connector is connected to the second connector.

2. The opto-electrical connection system according to claim 1,
wherein at least one optical element configured to optically couple corresponding optical fibers to each other is provided between each of the plurality of first optical fibers and each of the plurality of second optical fibers.

3. The opto-electrical connection system according to claim 1,
wherein an air gap is provided between a leading end of each of the plurality of first optical fibers and a leading end of each of the plurality of second optical fibers, and the air gap has a width of 50 μm or less.

4. The opto-electrical connection system according to claim 3,
wherein each leading end of the plurality of first optical fibers includes a first leading end face inclined with respect to a plane orthogonal to a longitudinal direction in which each first optical fiber extends,
wherein each leading end of the plurality of second optical fibers includes a second leading end face inclined with respect to a plane orthogonal to a longitudinal direction in which each second optical fiber extends, and
wherein the first leading end face faces the second leading end face when the first connector is connected to the second connector.

5. The opto-electrical connection system according to claim 2,
wherein each leading end of at least one of the plurality of first optical fibers or the plurality of second optical fibers is located at an inner side than an end face of the first housing or the second housing placing each leading end therein.

6. The opto-electrical connection system according to claim 1, further comprising
a spacer located between the first end face of the first housing and the second end face of the second housing.

7. The opto-electrical connection system according to claim 1,
wherein the first connector includes a first electrical sub-connector placing each leading end portion of the plurality of first conductors therein and a first optical sub-connector placing the plurality of first optical fibers therein,
wherein the second connector includes a second electrical sub-connector placing each leading end portion of the plurality of second conductors therein and a second optical sub-connector placing the plurality of second optical fibers therein,
wherein the first electrical sub-connector is configured to be connected to the second electrical sub-connector, and the first optical sub-connector is configured to be connected to the second optical sub-connector.

8. The opto-electrical connection system according to claim 7,
wherein the first electrical sub-connector includes a first guide pin, and the second electrical sub-connector includes a first guide hole corresponding to the first guide pin,
wherein the first optical sub-connector includes a second guide pin, and the second optical sub-connector includes a second guide hole corresponding to the second guide pin,
wherein the first electrical sub-connector is positioned with respect to the second electrical sub-connector by inserting the first guide pin into the first guide hole, and
wherein the first optical sub-connector is positioned with respect to the second optical sub-connector by inserting the second guide pin into the second guide hole.

9. The opto-electrical connection system according to claim 7,
wherein the first electrical sub-connector is configured to be movable relative to the first optical sub-connector, and the second electrical sub-connector is configured to be movable relative to the second optical sub-connector.

10. The opto-electrical connection system according to claim 1,
wherein the first connector and the second connector are configured to be couplable such that a first longitudinal direction in which the plurality of first conductors extend intersects with a second longitudinal direction in which the plurality of second conductors extend.

11. The opto-electrical connection system according to claim 10,
wherein the first end face of the first housing includes an inclination region inclined with respect to a plane orthogonal to the first longitudinal direction and a planar region extending along the plane orthogonal to the first longitudinal direction,
wherein the plurality of first conductors are exposed at the inclination region, and the plurality of first optical fibers are located in a portion corresponding to the planar region.

12. The opto-electrical connection system according to claim 10,
wherein at least one optical element configured to optically couple corresponding optical fibers to each other is provided between each of the plurality of first optical fibers and each of the plurality of second optical fibers, and the optical element is configured to bend an optical path between the optical fibers being optically coupled to each other.

13. An opto-electrical connector comprising:
a plurality of conductors;
a plurality of optical fibers; and
a housing placing each leading end portion of the plurality of conductors and each leading end portion of the plurality of optical fibers therein,
wherein the plurality of conductors are exposed at an end face of the housing, and
wherein each leading end of the plurality of optical fibers is located at an inner side than the end face of the housing such that the plurality of optical fibers are optically coupled to corresponding optical fibers in a non-contact state.

14. The opto-electrical connector according to claim 13, further comprising
an optical element configured to optically couple each of the plurality of optical fibers to each of the corresponding optical fibers.

15. The opto-electrical connector according to claim 13,
wherein the housing includes a plurality of first housing holes respectively placing the plurality of conductors therein, and a plurality of second housing holes respectively placing the plurality of optical fibers therein, and
wherein the opto-electrical connector further comprises
a positioning structure configured to position each of the plurality of optical fibers with respect to each of the corresponding optical fibers.
